(19) United States
(12) Patent Application Publication
(10) Pub. No.: US 2025/0317022 A1
(43) Pub. Date: Oct. 9, 2025

(54) MULTI-PHASE ROTARY MACHINE

(71) Applicant: Serene, LLC, Maineville, OH (US)

(72) Inventor: Scott Christopher Wilson, Maineville, OH (US)

(21) Appl. No.: 19/171,775

(22) Filed: Apr. 7, 2025

Related U.S. Application Data
(60) Provisional application No. 63/575,997, filed on Apr. 8, 2024.

(51) Int. Cl. H02K 3/28; H02K 1/16; H02K 1/2753

(52) U.S. Cl. CPC H02K 3/28; H02K 1/165; H02K 1/2753

(57) ABSTRACT

A rotary machine is provided that includes a rotor and a stator. The rotor includes a permanent magnet. The stator includes a spherical shell at least partially surrounding the permanent magnet. The stator also includes first, second, and third electromagnetic coils surrounding the spherical shell and configured for magnetic interaction with the permanent magnet.

### REFERENCE TO RELATED APPLICATIONS

This application claims priority of U.S. provisional patent application Ser. No. 63/575,997 filed Apr. 8, 2024, and hereby incorporates this patent application by reference herein in its entirety.

### TECHNICAL FIELD

The present disclosure relates to electric rotary machines such as motors and generators, and more particularly to a three-phase rotary machine having electromagnetic coils arranged around a stator shell.

### BACKGROUND

Electric motors are widely used in various applications to convert electrical energy into mechanical energy. These motors typically consist of a stationary component called the stator and a rotating component called the rotor. The interaction between magnetic fields generated by the stator and rotor produces rotational motion.

Three-phase electric motors are commonly employed in industrial and commercial settings due to their efficiency and smooth operation. These motors utilize three alternating currents that are out of phase with each other to create a rotating magnetic field in the stator. This rotating field interacts with the rotor to produce torque.

Conventional three-phase motors often have a cylindrical design with the stator surrounding the rotor. The stator contains windings arranged to produce the rotating magnetic field when energized by three-phase power. The rotor typically contains permanent magnets or electromagnetic windings that interact with the stator's magnetic field.

While effective, traditional cylindrical motor designs can have limitations in terms of size, weight, and power density for certain applications. Additionally, the fixed orientation of stator windings may constrain the motor's torque characteristics and efficiency across different operating conditions. Optimizing the spatial arrangement of electromagnetic components while maintaining manufacturability remains an ongoing challenge in electric motor design. Innovative motor topologies that can be readily manufactured while offering enhanced electromagnetic properties are of interest for advancing motor technology across various industries.

### BRIEF DESCRIPTION OF THE DRAWINGS

FIG. 1 is an exploded view depicting a spherical motor, in accordance with one embodiment, that includes a stator having three coils associated with a spherical shell;

FIG. 2 is an assembled view of the spherical motor of FIG. 1;

FIG. 3 is a schematic view depicting the three coils of FIG. 1 wired in a wye configuration and electrically connected with a three-phase power source;

FIG. 4 is a schematic view depicting the three coils of FIG. 1 wired in a delta configuration and electrically connected with a three-phase power source;

FIG. 5 is a left side view of the spherical motor of FIG. 1 depicting the three coils oriented in different planes with a silhouette of the circumference of the spherical shell shown in dashed line for reference;

FIG. 6 is a left side view of the spherical motor of FIG. 1;

FIG. 7 is a right side view of the spherical motor of FIG. 1;

FIG. 8 is an enlarged view of the intersection location of two intersecting coils, in accordance with one embodiment;

FIG. 9 is an enlarged view of the intersection location of two intersecting coils, in accordance with another embodiment;

FIG. 10 is an enlarged view of the intersection location of two intersecting coils, in accordance with yet another embodiment;

FIG. 11 is an exploded view depicting a spherical motor, in accordance with another embodiment, that includes a stator having six coils associated with a spherical shell;

FIG. 12 is an assembled view of the spherical motor of FIG. 11;

FIG. 13 is a schematic view depicting the six coils of FIG. 11 wired in a wye configuration and electrically connected with a three-phase power source;

FIG. 14 is a schematic view depicting the six coils of FIG. 11 wired in a delta configuration and electrically connected with a three-phase power source;

FIG. 15 is a left side view of the spherical motor of FIG. 11 depicting the six coils oriented in different planes with a silhouette of the circumference of the spherical shell shown in dashed line for reference;

FIG. 16 is a left side view of the spherical motor of FIG. 11;

FIG. 17 is a right side view of the spherical motor of FIG. 11; and

FIG. 18 is a perspective view depicting an alternative embodiment of a spherical shell for a stator.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For case of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Described herein are one or more example embodiments of a spherical three-phase motor that includes a rotor and a spherical-shaped stator. The rotor includes a permanent magnet that is coupled with a drive shaft that extends through the stator and is journaled relative to the stator by at least one bearing such that the rotor is rotatable about a fixed rotational axis defined by the driveshaft. The stator can include a spherical shell, and the permanent magnet can be housed within the shell such that the shell effectively surrounds the permanent magnet. Three different electromagnetic coils (i.e., one coil for each phase) can be routed around the circumference of the shell and can traverse a different path around the shell such that the path of each coil is angled relative to the path of each adjacent coil around the circumference of the shell. The three electromagnetic coils can cooperate to define the three different phases of the motor and can be electrically coupled to three-phase power source that facilitates generation of respective magnetic fields at the electromagnetic coils that interact with the permanent magnet to rotate the rotor about the rotational axis. The spherical shell of the stator can alternatively be any of a variety of non-spherical shapes (e.g., including corners or other edges, such as the shell being formed as a cube, and/or including brackets that facilitate mating and securement to an adjacent structure). The spherical motor can include any quantity of electromagnetic coils which, when a three phase configuration is implemented, can be any multiple of three (e.g., 3, 6, 9, 12, 15, 18, 21). When six or more electromagnetic coils are implemented, the electromagnetic coils can correspond to one of the three-phases, with each electromagnetic coil of a given phase being electrically coupled together. Other example embodiments of a spherical three-phase generator are also described that incorporate the principles and techniques disclosed herein for the three-phase motor.

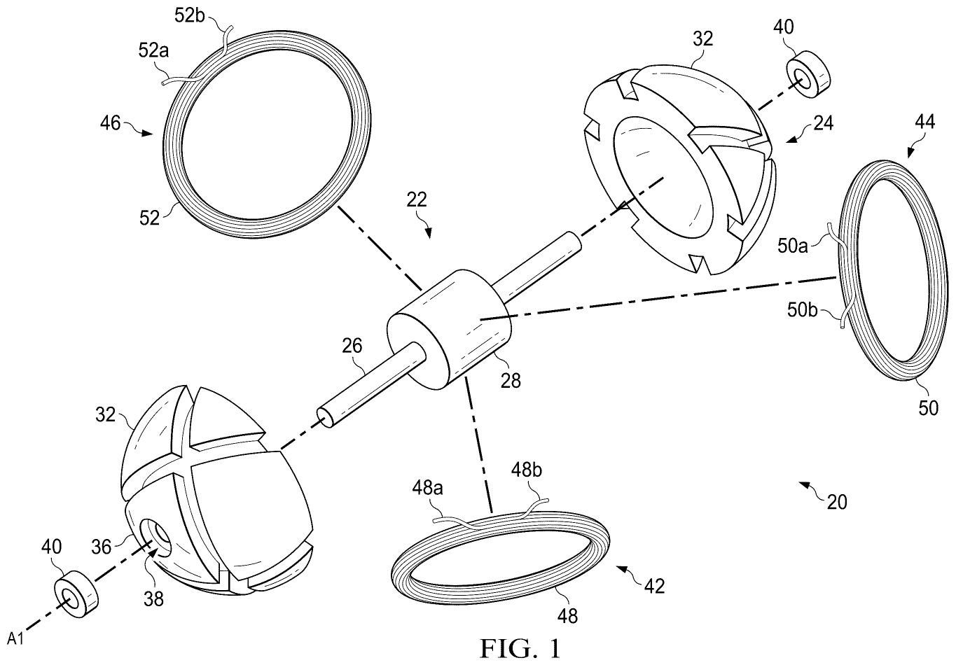

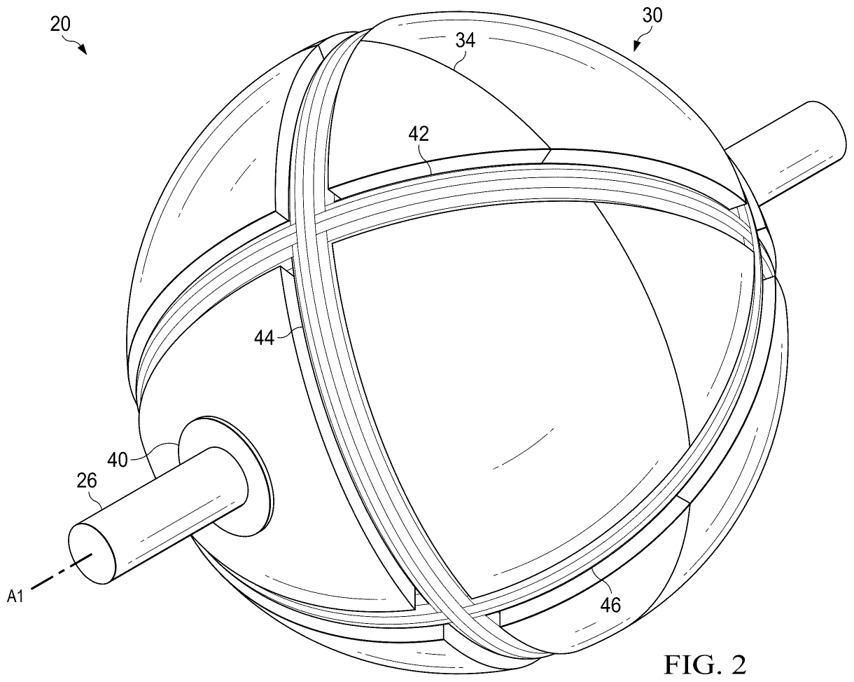

Embodiments are hereinafter described in detail in connection with the views and examples of FIGS. 1-10, wherein like numbers indicate the same or corresponding elements throughout the views. A three-phase spherical motor 20 (hereinafter the “spherical motor”) is illustrated in FIGS. 1 and 2 and can include a rotor 22 (FIG. 1) and a stator 24. The rotor 22 can include a driveshaft 26 and a permanent magnet 28 coupled with the driveshaft 26. The permanent magnet 28 can be affixed to the driveshaft 26 via welding, adhesive, fasteners or any other suitable affixing arrangement, such that the driveshaft 26 and the permanent magnet 28 are rotatable together about a rotational axis A1. The permanent magnet 28 is shown to be substantially cylindrically shaped with the north and south poles radially disposed with respect to the rotational axis A1. The permanent magnet 28 can alternatively be spherically shaped which can enhance the performance of the motor 20 relative to the cylindrically shaped magnet design described herein. It is to be appreciated that the permanent magnet 28 can be any of a variety of different shapes, such as cube shaped, for example, and/or any of a variety of different sizes.

The stator 24 can include a spherical shell 30 that includes a pair of hemispherical portions 32 that are substantially hollow and cooperate with each other to surround the permanent magnet 28 and rotatably support the driveshaft 26. The hemispherical portions 32 can be joined together along an equator 34 via adhesive, an interference fit, latching mechanisms (not shown) or any of a variety of suitable alternative joining techniques. Each hemispherical portion 32 can include a driveshaft support 36 that defines an opening 38 for receiving opposite ends of the driveshaft 26. The opposite ends of the driveshaft 26 can be journalled with respect to the driveshaft supports 36 via bearings 40 (FIG. 1) that surround the driveshaft 26. The rotational axis A1 of the rotor 22 can accordingly be fixed (e.g., one degree of freedom) with respect to the spherical shell 30. The permanent magnet 28 is effectively suspended within the spherical shell 30 by the driveshaft 26. The permanent magnet 28 and the spherical shell 30 can be sized to allow the permanent magnet 28 to be spaced entirely from the spherical shell 30. It is to be appreciated that although the spherical shell 30 is shown to be a two-part design that attaches at an equator, any of a variety of multipiece designs are contemplated for the spherical shell 30.

The stator 24 can also include first, second, and third electromagnetic coils 42, 44, 46 (collectively “the coils”) that are routed circumferentially around the spherical shell 30 and that each correlate to a different phase of the three-phase configuration of the spherical motor 20. In particular, the first coil 42 can correlate to the first phase of the spherical motor 20, the second coil 44 can correlate to the second phase of the spherical motor 20, and the third coil 46 can correlate to the third phase of the spherical motor 20.

The coils 42, 44, 46 can be distributed around the spherical shell 30 such that each coil 42, 44, 46 surrounds the rotor 22 with the rotational axis A1 extending through each coil 42, 44, 46. Each coil 42, 44, 46 can traverse a different path along the spherical shell 30 which enables the coils 42, 44, 46 to generate a varying magnetic field around the permanent magnet 28 that facilitates rotation of the rotor 22 about the rotational axis A1, as will be described in further detail below.

Each coil 42, 44, 46 can comprise a coiled wire that is formed by winding an individual wire (48, 50, 52), respectively around the spherical shell 30. The wires 48, 50, 52 for each respective coil 42, 44, 46 can terminate at a pair of wire ends (e.g., 48a and 48b, 50a and 50b, and 52a and 52b, respectively (see FIG. 1)) that facilitates electrical connection thereto. Each of the wires 48, 50, 52 can include a conductor (not shown) that is surrounded by an insulating jacket (not shown) that prevents the conductor from electrically contacting itself and the conductors of adjacent coils. The insulating jacket can be formed of any of a variety of insulating materials, such as enamel or elastomeric. The size and/or quantity of windings can be selected to achieve a desired performance from the motor (e.g., a maximum output speed or maximum output torque). In one embodiment, the quantity of windings for each of the coils 42, 44, 46 can be the same. However, in some embodiments, the quantity of the windings of the coils 42, 44, 46 might be different to accommodate a particular application or coil configuration.

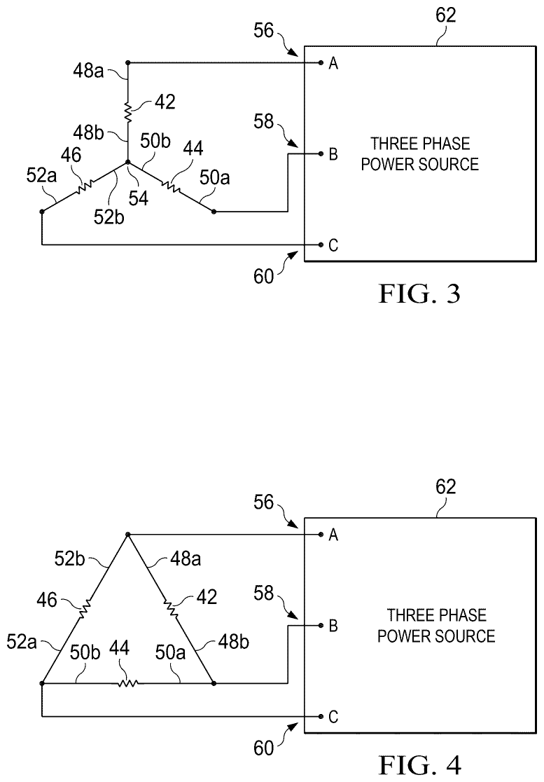

Referring now to FIG. 3, the coils 42, 44, 46 can be wired together in a wye configuration with the wire ends 48b, 50b, 52b electrically connected together at a common node 54 and the wire ends 48a, 50a, 52a coupled to respective outputs 56, 58, 60 of a three-phase power source 62. The three-phase power source 62 can deliver AC power to each of the coils 42, 44, 46 that is 120 degrees out of phase relative to the other coils. The AC power can generate respective magnetic fields at the coils 42, 44, 46 that oscillate and interact with the permanent magnet 28 to rotate the rotor 22 about the rotational axis A1.

The three-phase power source 62 can be any of a variety of suitable power sources for powering the spherical motor 20, such as, for example, a three-phase motor controller. The three-phase power source 62 can be a variable controller that varies the power delivered to the spherical motor 20 to control the rotational speed of the rotor 22. The spherical motor 20 can be used to deliver electromotive force for any of a variety of applications such as, for example, in a vehicle or in an industrial setting. In any of these applications, the component(s) that is/are to be driven by the spherical motor 20 can be operably coupled to the driveshaft 26 to facilitate powering therefrom.

In an alternative embodiment, as illustrated in FIG. 4, the coils 42, 44, 46 can be wired together in a delta configuration. To form the delta configuration, the wire ends 48a, 52b of the first and third coils 42, 46 can be electrically connected together, the wire ends 48b, 50a of the first and second coils 42, 44 can be electrically connected together, and the wire ends 50b, 52a of the second and third coils 44, 46 can be electrically connected together. The connection points between the first, second, and third coils 42, 44, 46 can be coupled to the respective outputs 56, 58, 60 of the three-phase power source 62.

The coils 42, 44, 46 can be positioned on the spherical shell 30 such that each coil 42, 44, 46 traverses a different great circle path around the spherical shell 30. It is to be understood that the path being described as a great circle can be understood to mean that each coil can be oriented in a plane that passes through the center of the spherical shell 30 and divides the spherical shell 30 into two substantially equal imaginary hemispheres.

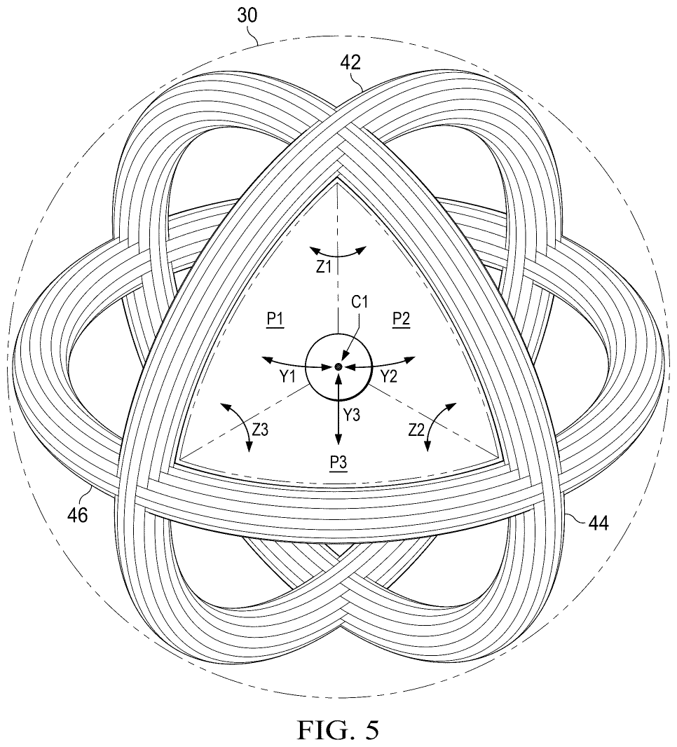

Referring now to FIG. 5, each of the coils 42, 44, 46 are shown to be oriented in a plane P1, a plane P2, and a plane P3, respectively. The coils 42, 44, 46 are distributed about the spherical shell 30 (e.g., along their great circle paths) such that each of the planes P1, P2, P3 passes through (i.e., intersects) a center C1 of the spherical shell 30 which can be understood to be the geometric center of the spherical shell 30. The rotor 22 can be positioned such that the rotational axis A1 extends through the center C1, which in many instances can also be the geometric center of the rotor 22 and thus intersected by the rotational axis A1. Because each of the great circle paths of the coils 42, 44, 46 are different, each of the planes P1, P2, P3 can divide the spherical shell 30 into different hemispheres.

Referring again to FIG. 5, the coils 42, 44, 46 can be distributed around the spherical shell 30 with respect to the rotor 22 such that the coils 42, 44, 46 are angled with respect to the rotational axis A1 by respective angles Y1, Y2, Y3 (as measured from their corresponding planes P1, P2, P3). The coils 42, 44, 46 can be distributed around the spherical shell 30 with respect to each other such that the first coil 42 and the second coil 44 are angled with respect to each other by a dihedral angle Z1 (as measured between their corresponding planes P1, P2), the second coil 44 and the third coil 46 are angled with respect to each other by a dihedral angle Z2 (as measured between their corresponding planes P2, P3), and the first coil 42 and the third coil 44 are angled with respect to each other by a dihedral Z3 (as measured between their corresponding planes P1, P3).

The coils 42, 44, 46 are shown to be distributed substantially evenly and uniformly around the rotational axis A1 and with respect to each other such that the angles Y1, Y2, Y3 are substantially the same and the dihedral angles Z1, Z2, Z3 are substantially the same. In other words, the coils 42, 44, 46 can be equiangularly positioned relative to the rotational axis A1 and equiangularly positioned relative to each other. The distribution of the coils 42, 44, 46 around the spherical shell 30 in this manner can enable the varying magnetic field generated by the coils 42, 44, 46 to be consistently and uniformly applied to the permanent magnet 28 thus alleviating undesirable surging or other anomalies when powering the rotation of the rotor 22. It is to be understood that the coils 42, 44, 46 being described herein as being equiangularly positioned relative to the rotational axis A1 can be understood to mean that the angles A1, A2, A3 of the coils 42, 44, 46 are substantially the same regardless of the positioning of the coils 42, 44, 46 relative to each other. It is also to be understood that the coils 42, 44, 46 being described herein as being equiangularly positioned relative to each other can be understood to mean that the dihedral angles Z1, Z2, Z3 of the coils 42, 44, 46 are substantially the same regardless of the positioning of the coils 42, 44, 46 relative to the rotational axis A1.

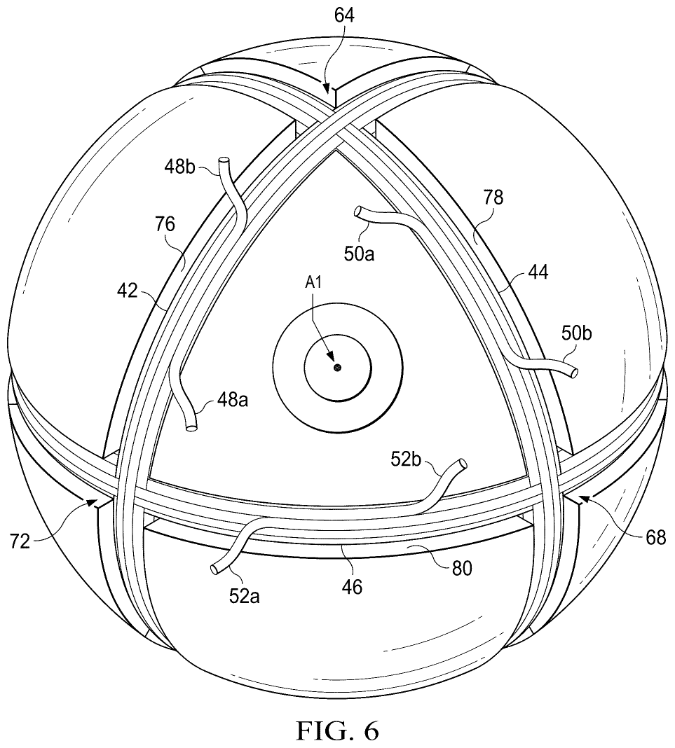

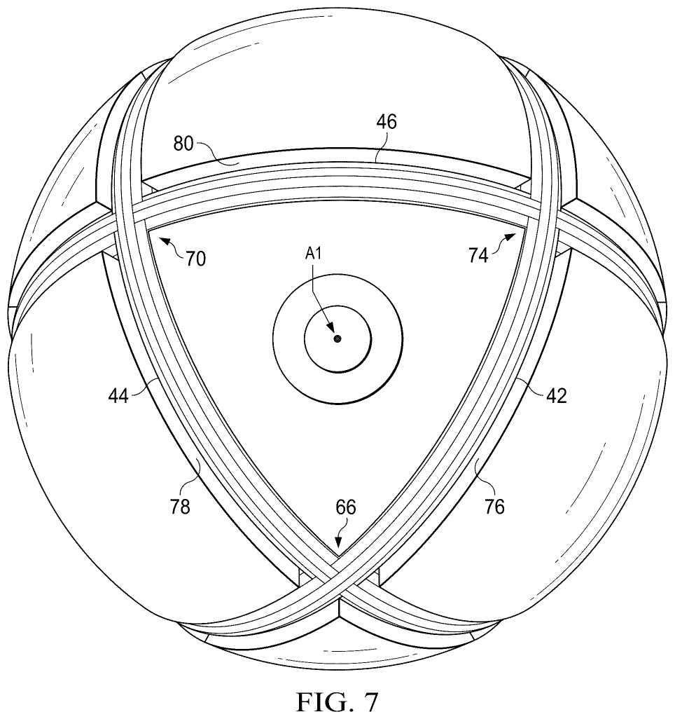

The coils 42, 44, 46 can each traverse one another at two different intersection locations located on polar opposite sides of the spherical shell 30. For example, as illustrated in FIGS. 6 and 7, the first coil 42 can intersect the second coil 44 at intersection locations 64, 66 (FIGS. 6 and 7, respectively). The second coil 44 can intersect the third coil 46 at intersection locations 68, 70 (FIGS. 6 and 7, respectively). The first coil 42 can intersect the third coil 46 at intersection locations 72, 74 (FIGS. 6 and 7, respectively).

In one embodiment, the coils 42, 44, 46 can be distributed around the spherical shell 30 such that the angles Y1, Y2, Y3 are about 30 degrees and the dihedral angles Z1, Z2, Z3 are about 60 degrees. In such an embodiment, each pair of coils that traverses each other at the different intersection locations 64, 66, 68, 70, 72, 74 is angled with respect to each other by about 120 degrees. It is to be appreciated that the coils 42, 44, 46 can be angled with respect to the rotational axis A1 by any acute angle. It is also to be appreciated that in certain scenarios, the coils 42, 44, 46 might not be equiangularly angled relative to the rotational axis and/or each other to accommodate a particular application or motor configuration, such as, for example, when the stator shell is non-spherical.

Referring again to FIG. 6, the spherical shell 30 can define a plurality of channels 76, 78, 80 that are routed along the great circle paths described above. The channels 76, 78, 80 can receive the first coil 42, the second coil 44, and the third coil 46, respectively. The channels 76, 78, 80 can serve as guides during the winding of the coils 42, 44, 46 to ensure that the coils are tightly wound and accurately maintained on the correct great circle path described above. The channels 76, 78, 80 can also prevent the windings of the coils 42, 44, 46 from being inadvertently repositioned during manufacturing or handling of the spherical motor 20. It is to be appreciated that the pattern of the channels 76, 78, 80 can be configured to achieve any desired distribution of the coils 42, 44, 46 around the spherical shell 30. The spherical shell 30 can be formed of a non-conductive, non-ferrous material, such as a thermoplastic, to prevent the spherical shell 30 from inadvertently imparting undesirable noise into the electromagnetic interaction between the permanent magnet 28 and the coils 42, 44, 46.

Various different methods of winding the coils 42, 44, 46 around the spherical shell 30 will now be discussed. In one embodiment, the first coil 42 can be wound onto the spherical shell 30 first, followed by the second coil 44 and then the third coil 46 such that the coils 42, 44, 46 are effectively layered. In such an embodiment, the first coil 42 can pass beneath the second coil 44 at the two intersection locations 64, 66, the second coil 44 can pass beneath the third coil 46 at the intersection locations 68, 70 and the third coil 44 can pass over the first coil 42 at the intersection locations 72, 74. Winding the coils 42, 44, 46 in this manner can be time and cost effective since each coil 42, 44, 46 can be wound onto the spherical shell 30 independently. However, when utilizing this winding configuration, the second and third coils 44, 46 can be spaced slightly further from the center C1 of the spherical shell 30 than the first coil. In large scale applications, the slight difference in the diameter of the coils 42, 44, 46 can cause undesired undesirable surging or other anomalies when powering the rotation of the rotor 22.

In another embodiment, the first coil 42 can be wound onto the spherical shell 30 first, followed by the second coil 44. The third coil 46 can then be wound over the second coil 44 and threaded beneath the first coil 42. In such an embodiment, the first coil 42 can pass beneath the second coil 44 at the two intersection locations 64, 66, the second coil 44 can pass under the third coil 46 at the intersection locations 68, 70, and the third coil 44 can pass under the first coil 42 at the intersection locations 72, 74 such that the coils 42, 44, 46 are routed in an over-under pattern with respect to each other (i.e., the first coil 42 is routed under the second coil 44 and over the third coil 46, the second coil 44 is routed over the first coil 42 and under the third coil 46, and the third coil 46 is routed under the first coil 42 and over the second coil 44). Utilizing this winding configuration can alleviate some of the shortcomings for the layered winding method discussed above but can be more expensive and time consuming to implement. Even still, for certain applications, the over-under routing pattern might still cause undesired anomalies when powering the rotation of the rotor 22.

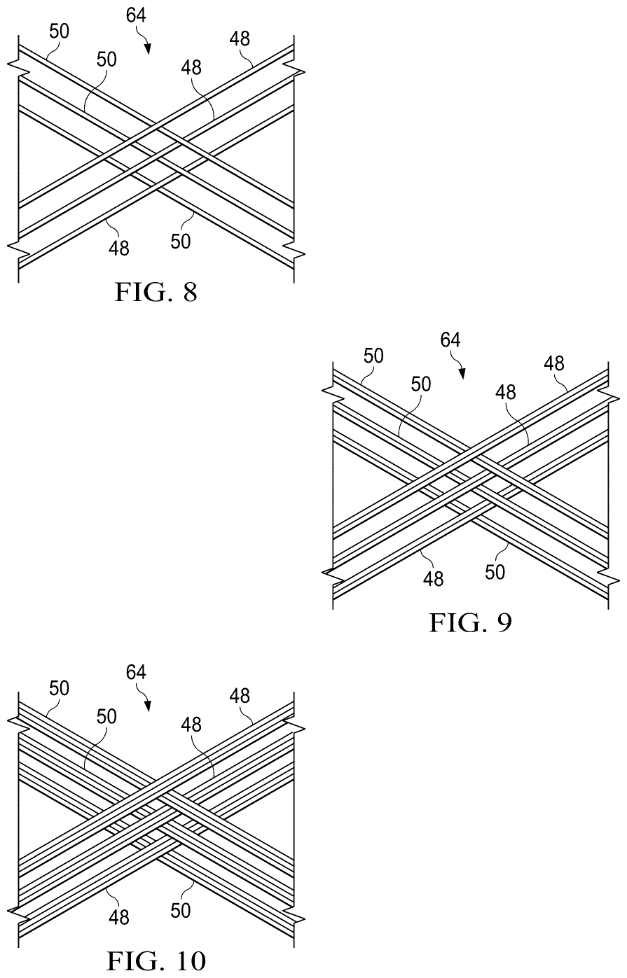

In yet another embodiment, each of the wires for the coils 42, 44, 46 can be wound with respect to each other to interleave the wires. In such an embodiment, each wire or subset of wires of a given coil is sandwiched between the respective wire or subsets of wires of the other coils at the intersection locations 64, 66, 68, 70, 72, 74. FIGS. 8-10 illustrate various examples of how the wires 48, 50 of the first and second coils 42, 44, respectively, are interleaved at the intersection location 64 and can be understood to be representative of how the wires at the other intersection locations can also be interleaved. As illustrated in FIG. 8, the individual strands of the wire 48 from the first coil 42 can be interleaved with individual strands of the wire 50 from the second coil 44 such that each strand of one of the wires 48, 50 is sandwiched between adjacent strands of the other wire. As illustrated in FIG. 9, different pairs of strands of the wire 48 from the first coil 42 can be interleaved with different pairs of strands of the wire 50 from the second coil 44 such that each pair of strands of one of the wires 48, 50 is sandwiched between adjacent pairs of strands of the other wire. As illustrated in FIG. 10, different triads of strands of the wire 48 from the first coil 42 can be interleaved with different triads of strands of the wire 50 from the second coil 44 such that each triad of strands of one of the wires 48, 50 is sandwiched between adjacent triads of strands of the other wire. It is to be appreciated that although strand groupings of one, two, and three are described above, any quantity of wire strands can be used to interleave the coils 42, 44, 46 together at the intersection points. Utilizing this winding configuration can alleviate some of the shortcomings of the layered and over-under winding methods discussed above but can be more expensive and time consuming to implement. It is to be appreciated that the motor configuration described above and illustrated in FIGS. 1-10 can have a power factor approaching unity and can be more efficient, powerful and more controllable than conventional three-phase motors.

The motor configuration described above and illustrated in FIGS. 1-10 may also be utilized as a generator. In such an application, mechanical energy (e.g., rotational energy) can be applied to the driveshaft 26 to rotate the rotor 22 about the rotational axis A1 thereby rotating the permanent magnet 28 relative to the coils 42, 44, 46. This relative motion between the permanent magnet 28 and the coils 42, 44, 46 can induce electrical currents in the coils 42, 44, 46 due to electromagnetic induction. The spherical arrangement of the coils 42, 44, 46 around the permanent magnet 28 can allow for efficient conversion of mechanical energy into electrical energy across multiple phases. The equiangular positioning of the coils 42, 44, 46 relative to the rotational axis A1 and to each other may contribute to balanced power generation across the three phases. In some cases, the generated electrical energy may be three-phase AC power that can be utilized directly or converted to other forms as needed for various applications.

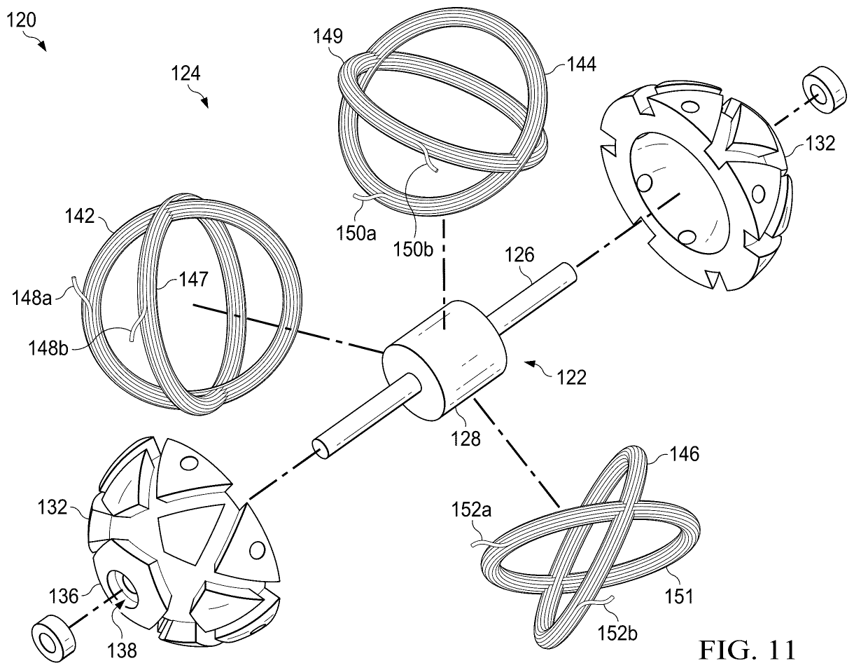

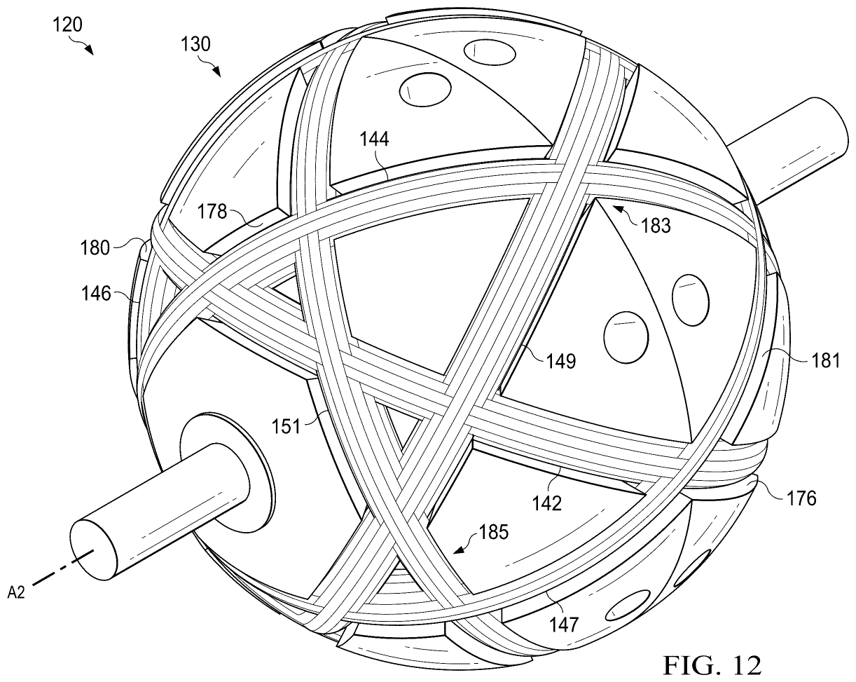

An alternative embodiment of a spherical motor 120 is illustrated in FIGS. 11-21 and can be similar to, or the same as, the spherical motor of FIGS. 1-10. For example, as illustrated in FIGS. 11 and 12, the spherical motor 120 can include a rotor 122 and a stator 124. The rotor 122 can include a driveshaft 126 and a permanent magnet 128. The stator 124 can include a spherical shell 130 that includes a pair of hemispherical portions 132 that each includes a driveshaft support 136 for supporting the driveshaft 126. The driveshaft supports 136, however, can project outwardly from the rest of the spherical shell 30 and are substantially hexagonal-shaped. Additionally, the stator 124 can include six coils instead of three coils. The six coils can comprise a first coil 142, a second coil 144, a third coil 146, a fourth coil 147, a fifth coil 149, and a sixth coil 151.

The six coils can be arranged into complementary pairs, with each pair corresponding to a different phase. The first and fourth coils 142, 147, can be a complementary pair that correlates to the first phase. The second and fifth coils 144, 149, can be a complementary pair that correlates to the second phase. The third and sixth coils 146, 151 can be a complementary pair that correlates to the third phase.

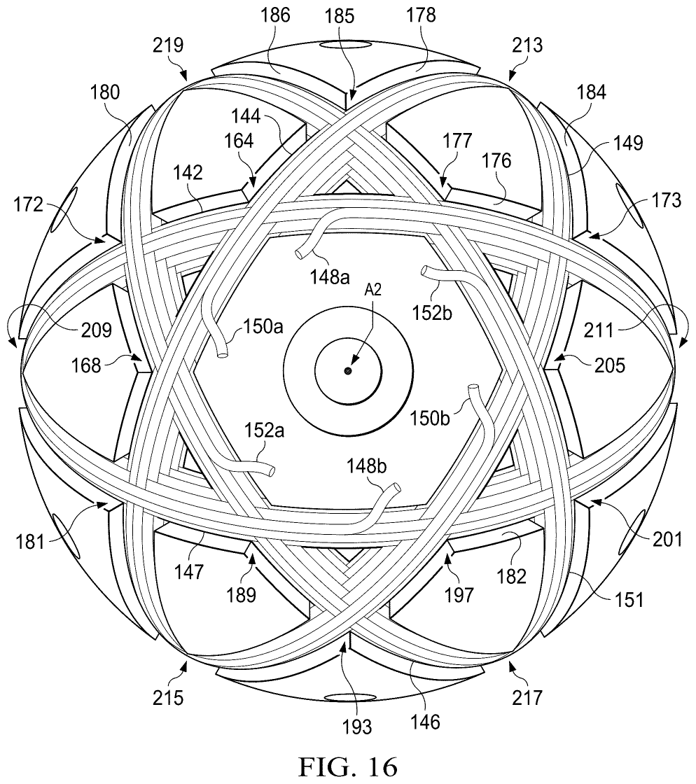

The coils 142, 144, 146, 147, 149, 151 can be distributed around the spherical shell 130 such that each coil 142, 144, 146, 147, 149, 151 surrounds the rotor 122 with the rotational axis A2 extending through each coil 142, 144, 146, 147, 149, 151. As illustrated in FIGS. 12 and 16, the spherical shell 130 can define a plurality of channels 176, 178, 180, 182, 184, 186 that accommodate the coils 142, 144, 146, 147, 149, 151, respectively.

Each complementary pair of coils can be formed from an individual wire that terminates at a pair of wire ends with each wire end being located on a different coil. For example, the first and fourth coils 142, 147 can terminate at respective wire ends 148a and 148b. The second and fifth coils 144, 149 can terminate at respective wire ends 150a and 150b. The third and sixth coils 146, 151 can terminate at respective wire ends 152a and 152b. Each of the coils can have the same quantity of windings. The coils of each complementary pair of coils can be counter-wound relative to one another (i.e., one coil is wound clockwise around the spherical shell 130 and the other coil is wound counterclockwise around the spherical shell 130) to allow the wire ends to be located on the same side of the spherical shell 130 for ease in electrical connection together and to a three phase power source. Although the complementary pairs of coils are described as being formed of an individual wire, it is to be appreciated that the coils of a complementary pair of coils can be formed of separate wires that are electrically coupled together, via soldering or a butt splice, after winding the coils onto the spherical shell 130.

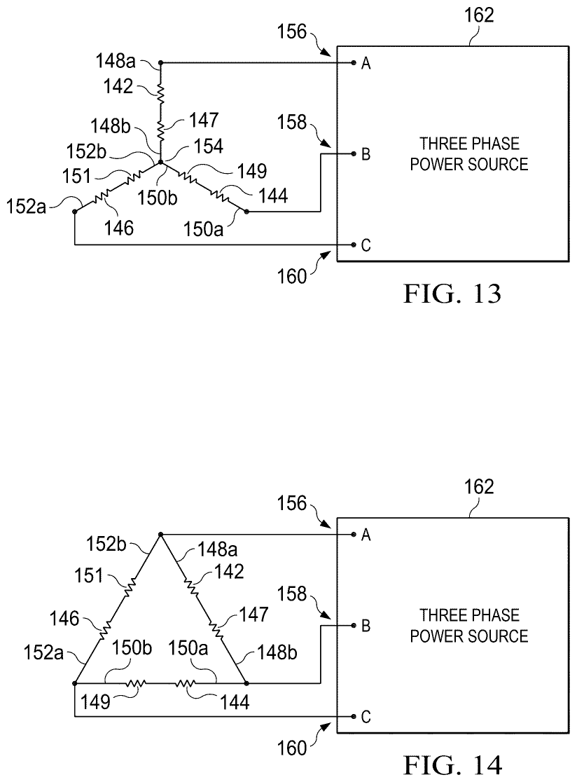

Referring now to FIG. 13, the complementary pairs of coils 142 and 147, 144 and 149, and 146 and 151 can be wired together in a wye configuration with the wire ends 148b, 150b, 152b electrically connected together at a common node 154 and the wire ends 148a, 150a, 152a coupled to respective outputs 156, 158, 160 of a three-phase power source 162. In an alternative arrangement, as illustrated in FIG. 14, the complementary pairs of coils 142 and 147, 144 and 149, and 146 and 151 can be wired together in a delta configuration. To form the delta configuration, the wire ends 148b and 150a of the fourth and second coils 147, 144 can be electrically coupled together, the wire ends 150b and 152a of the fifth and third coils 149, 146 can be electrically coupled together, and the wire ends 152b and 148a of the sixth and first coils 151, 142 can be electrically coupled together. Outputs 156, 158, 160 from the three-phase power source 162 can be electrically coupled between the connection between the first and fourth coils 142, 147, between the connection between the second and fifth coils 144, 149, and between the connection between the third and sixth coils 146, 151, respectively.

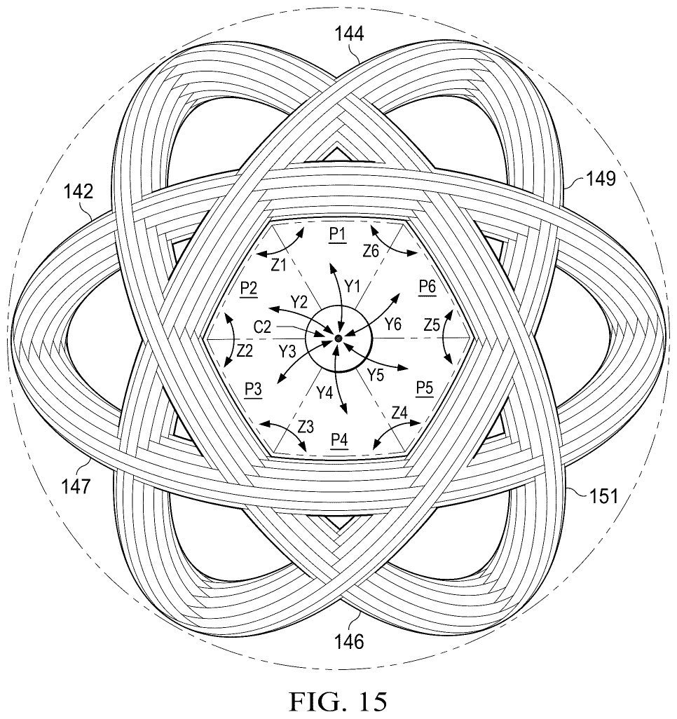

Referring now to FIG. 15, each of the coils 142, 144, 146, 147, 149, 151 are shown to be oriented in planes P1, P2, P3, P4, P5, P6, respectively, that all pass through a center C2 of the spherical shell 130. The coils 142, 144, 146, 147, 149, 151 can be distributed around the spherical shell 130 such that the coils 142, 144, 146, 147, 149, 151 are angled with respect to the rotational axis A2 by respective angles Y1, Y2, Y3, Y4, Y5, Y6 (as measured from their corresponding planes P1, P2, P3, P4, P5, P6). The coils 142, 144, 146, 147, 149, 151 can be distributed around the spherical shell 130 with respect to each other such that the first coil 142 and the second coil 144 are angled with respect to each other by a dihedral angle Z1 (as measured between their corresponding planes P1, P2), the second coil 144 and the third coil 146 are angled with respect to each other by a dihedral angle Z2 (as measured between their corresponding planes P2, P3), the third coil 146 and the fourth coil 147 are angled with respect to each other by a dihedral angle Z3 (as measured between their corresponding planes P3, P4), the fourth coil 147 and the fifth coil 149 are angled with respect to each other by a dihedral angle Z4 (as measured between their corresponding planes P4, P5), the fifth coil 149 and the sixth coil 151 are angled with respect to each other by a dihedral angle Z5 (as measured between their corresponding planes P5, P6), and the sixth coil 151 and the first coil 142 are angled with respect to each other by a dihedral angle Z6 (as measured between their corresponding planes P6, P1).

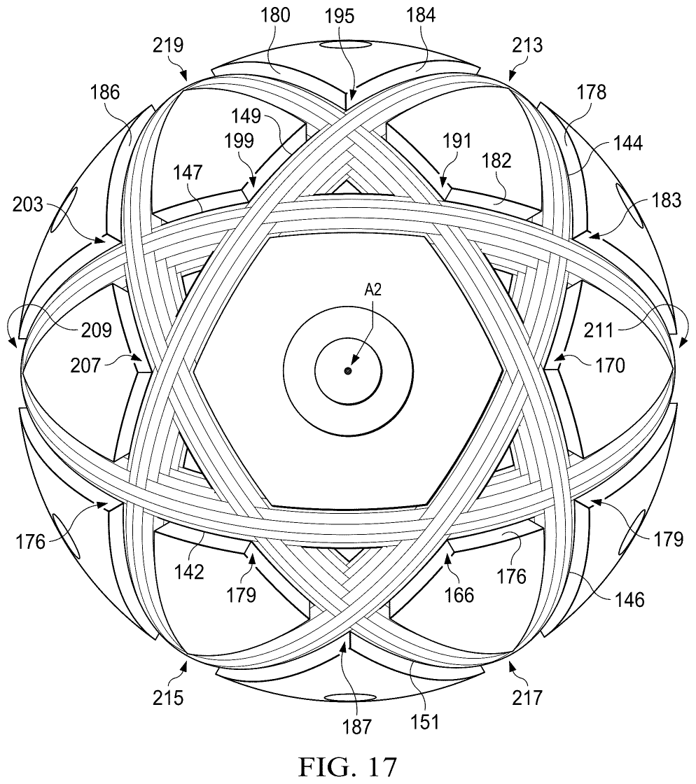

As illustrated in FIGS. 16 and 17, the coils 142, 144, 146, 147, 149, 151 can each traverse one another at two different intersection locations located on polar opposite sides of the spherical shell 130. For example, the first coil 142 can intersect the second coil 144 at intersection locations 164, 166. The second coil 144 can intersect the third coil 146 at intersection locations 168, 170. The first coil 142 can intersect the third coil 146 at intersection locations 172, 174. The first coil 142 can intersect the fifth coil 149 at intersection locations 173, 175. The first coil 142 can intersect the sixth coil 159 at intersection locations 177, 179. The second coil 144 can intersect the fourth coil 147 at intersection locations 181, 183. The second coil 144 can intersect the sixth coil 151 at intersection locations 185, 187. The third coil 146 can intersect the fourth coil 147 at intersection locations 189, 191. The third coil 146 can intersect the fifth coil 149 at intersection locations 193, 195. The fourth coil 147 can intersect the fifth coil 149 at intersection locations 197, 199. The fourth coil 147 can intersect the sixth coil 151 at intersection locations 201, 203. The fifth coil 149 can intersect the sixth coil 151 at intersection locations 205, 207. The complementary pairs of coils 142 and 147, 144 and 149, and 146 and 151 can intersect one another at intersection locations 209, 211, 213, 215, 217, 219, respectively, along the equator of the spherical shell 130.

The coils 142, 144, 146, 147, 149, 151 can be equiangularly positioned relative to the rotational axis A2 and equiangularly positioned relative to each other. In one embodiment, the coils 142, 144, 146, 147, 149, 151 can be distributed around the spherical shell 30 such that the angles Y1, Y2, Y3, Y4, Y5, Y6 are about 30 degrees and the dihedral angles Z1, Z2, Z3, Z4, Z5, Z6 are about 30 degrees. In such an embodiment, each pair of coils that traverses each other at the different intersection locations 164, 166, 168, 170, 172, 173, 174, 175, 177, 179, 181, 183, 185, 187, 189, 191, 193, 195, 197, 199, 201, 203, 205, 207 is angled with respect to each other by about 30 degrees. It is to be appreciated that the coils 142, 144, 146, 147, 149, 151 can be angled with respect to the rotational axis A2 by any acute angle. It is also to be appreciated that in certain scenarios, the coils 142, 144, 146, 147, 149, 151 might not be equiangularly angled relative to the rotational axis and/or each other to accommodate a particular application or motor configuration, such as, for example, when the stator shell is non-spherical.

Various different methods of winding the coils 142, 144, 146, 147, 149, 151 around the spherical shell 30 can be implemented in a similar manner as discussed above for coils 42, 44, 46. In one example, the first coil 142 can be wound onto the spherical shell 130 first, followed by the second, third, fourth, fifth and sixth coils 144, 146, 147, 149, 151 such that the coils 142, 144, 146 are effectively layered. In another example, the coils 144, 146, 147, 149, 151 can be routed in an over-under pattern relative to one another. In yet another example, the coils 144, 146, 147, 149, 151 can be interleaved at the intersection locations.

It is to be appreciated that the six coil arrangement described above can provide a higher magnetic flux density and thus better efficiency than the three coil arrangement. It is also to be appreciated that although three and six coil arrangements are described above, a spherical motor can include two coils (e.g., in a two-phase configuration) or more than three coils and configured in accordance with the principles and teachings herein. In three-phase configurations, the quantity of electromagnetic coils can be any multiple of three (e.g., 9, 12, 15, 18, 21).

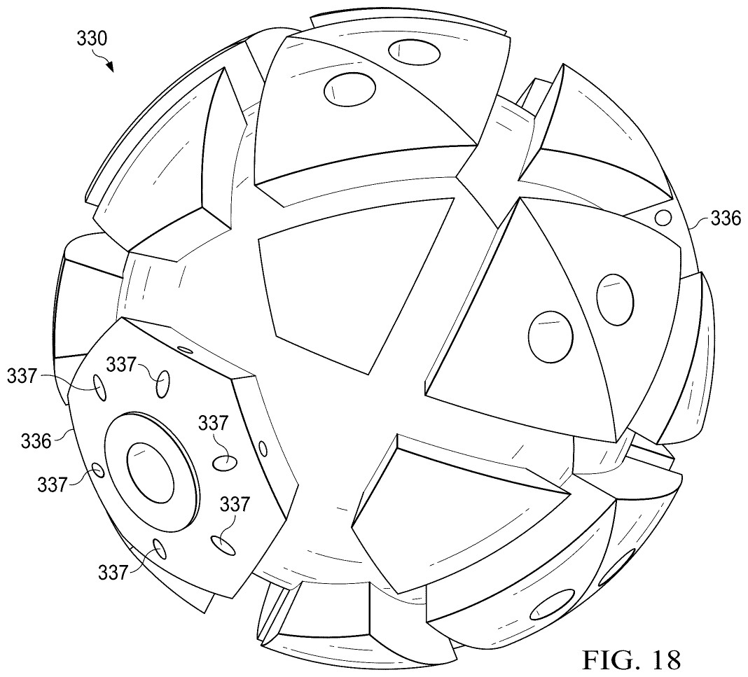

Referring now to FIG. 18, an alternative embodiment of a spherical shell 330 is illustrated and can be similar to, or the same in many respects as, the spherical shell 130. For example, the spherical shell 330 can include a pair of driveshaft supports 336 and can define a plurality of channels for accommodating the three or six coil wiring arrangements described above. The driveshaft supports 336, however, can include a plurality of openings 337 that can receive the wire ends from the coils. The driveshaft supports 336 can accordingly serve as a mounting locations for the wire ends to allow for case in electrical connection thereto.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. A spherical rotary machine comprising:
a rotor comprising
a permanent magnet configured for rotation about a rotational axis;
a stator comprising:
a spherical shell at least partially surrounding the permanent magnet;
a first electromagnetic coil surrounding the spherical shell and corresponding to a first phase of the spherical rotary machine;
a second electromagnetic coil surrounding the spherical shell and corresponding to a second phase of the spherical rotary machine; and
a third electromagnetic coil surrounding the spherical shell and corresponding to a third phase of the spherical rotary machine, the first electromagnetic coil, the second electromagnetic coil, and the third electromagnetic coil being configured to magnetically interact with the permanent magnet, wherein the first electromagnetic coil, the second electromagnetic coil, and the third electromagnetic coil each traverse a different great circle path around the spherical shell.

2. The spherical rotary machine of claim 1, wherein any two of the first electromagnetic coil, the second electromagnetic coil, and the third electromagnetic coil intersect each other at two different intersection locations.

3. The spherical rotary machine of claim 2 wherein each of the first electromagnetic coil, the second electromagnetic coil, and the third electromagnetic coil are equiangularly positioned relative to the rotational axis.

4. The spherical rotary machine of claim 3 wherein each of the first electromagnetic coil, the second electromagnetic coil, and the third electromagnetic coil are equiangularly positioned relative to each other.

5. The spherical rotary machine of claim 4 wherein the first electromagnetic coil, the second electromagnetic coil, and the third electromagnetic coil are positioned such that any two electromagnetic coils that intersect at the different intersection locations are angled with respect to each other by approximately 120 degrees.

6. The spherical rotary machine of claim 3 wherein each of the first electromagnetic coil, the second electromagnetic coil, and the third electromagnetic coil are angled relative to the rotational axis by an acute angle.

7. The spherical rotary machine of claim 1 wherein:
the rotor further comprises a driveshaft; and
the spherical shell rotatably supports the driveshaft at opposing sides of the spherical shell.

8. The spherical rotary machine of claim 1 wherein:
the rotary machine comprises a motor;
the first electromagnetic coil is configured for electrical connection to a first phase of a three-phase power source;
the second electromagnetic coil is configured for electrical connection to a second phase of a three-phase power source;
the third electromagnetic coil is configured for electrical connection to a third phase of a three-phase power source; and
the first electromagnetic coil, the second electromagnetic coil, and the third electromagnetic coil are configured to generate respective magnetic fields that interact with the permanent magnet to produce rotation of the rotor about the rotational axis.

9. The spherical rotary machine of claim 1 wherein the spherical shell defines a plurality of channels that are configured to receive the first electromagnetic coil, the second electromagnetic coil, and the third electromagnetic coil.

10. A spherical rotary machine comprising:
a rotor comprising
a permanent magnet configured for rotation about a rotational axis;
a stator comprising:
a spherical shell at least partially surrounding the permanent magnet;
a plurality of electromagnetic coils surrounding the spherical shell, the plurality of electromagnetic coils being configured to magnetically interact with the permanent magnet, wherein:
each electromagnetic coil of the plurality of electromagnetic coils traverses a different great circle path around the spherical shell; and
each electromagnetic coil of the plurality of electromagnetic coils intersects every other electromagnetic coil of the plurality of electromagnetic coils at two intersection locations.

11. The spherical rotary machine of claim 10 wherein each electromagnetic coil of the plurality of electromagnetic coils is equiangularly positioned relative to the rotational axis.

12. The spherical rotary machine of claim 11 wherein the electromagnetic coils are equiangularly positioned relative to one another.

13. The spherical rotary machine of claim 11 wherein each electromagnetic coil of the plurality of electromagnetic coils is angled relative to the rotational axis by an acute angle.

14. The spherical rotary machine of claim 11 wherein:
the rotor further comprises a driveshaft; and
the spherical shell rotatably supports the driveshaft at opposing sides of the spherical shell.

15. The spherical rotary machine of claim 11 wherein:
the rotary machine comprises a motor; and
the plurality of electromagnetic coils is configured to generate magnetic fields that interact with the permanent magnet to produce rotation of the rotor about the rotational axis.

16. The spherical rotary machine of claim 15 wherein:
the plurality of electromagnetic coils comprises a first complementary pair of electromagnetic coils, a second complementary pair of electromagnetic coils, and a third complementary pair of electromagnetic coils;
the first complementary pair of electromagnetic coils are electrically coupled together and configured for electrical connection to a first phase of a three-phase power source;
the second complementary pair of electromagnetic coils are electrically coupled together and configured for electrical connection to a second phase of a three-phase power source; and
the third complementary pair of electromagnetic coils are electrically coupled together and configured for electrical connection to a third phase of a three-phase power source.

17. The spherical rotary machine of claim 16 wherein the electromagnetic coils are positioned such that any two electromagnetic coils that intersect at each of the two intersection locations are angled with respect to each other by approximately 60 degrees.

18. A rotary machine comprising:
a rotor comprising a permanent magnet configured for rotation about a rotational axis;
a stator comprising:
a shell rotatably at least partially surrounding the permanent magnet;
a first electromagnetic coil surrounding the shell and configured to magnetically interact with the permanent magnet;
a second electromagnetic coil surrounding the shell and configured to magnetically interact with the permanent magnet;
a third electromagnetic coil surrounding the shell and configured to magnetically interact with the permanent magnet, wherein:
each electromagnetic coil of the plurality of electromagnetic coils traverses a different path around the shell;
each electromagnetic coil of the plurality of electromagnetic coils intersects every other electromagnetic coil of the plurality of electromagnetic coils at two intersection locations; and
each of the first electromagnetic coil, the second electromagnetic coil, and the third electromagnetic coil are equiangularly positioned relative to the rotational axis.

19. The rotary machine of claim 17 wherein each of the first electromagnetic coil, the second electromagnetic coil, and the third electromagnetic coil are equiangularly positioned relative to each other.

20. The rotary machine of claim 18 wherein the first electromagnetic coil, the second electromagnetic coil, and the third electromagnetic coil are positioned such that any two electromagnetic coils that intersect at the two intersection locations are angled with respect to each other by approximately 120 degrees.
